(19) United States
(12) Patent Application Publication
(10) Pub. No.: US 2024/0246171 A1
(43) Pub. Date: Jul. 25, 2024

(54) MULTI-FOCAL LASER MARKING, DICING, AND SCRIBING

(71) Applicant: The Trustees of Princeton University, Princeton, NJ (US)

(72) Inventors: Craig B. Arnold, Skillman, NJ (US); Xiaohan Du, Princeton, NJ (US); Camilo Florian Baron, Princeton, NJ (US)

(73) Assignee: The Trustees of Princeton University, Princeton, NJ (US)

(21) Appl. No.: 18/421,441

(22) Filed: Jan. 24, 2024

Related U.S. Application Data
(60) Provisional application No. 63/440,823, filed on Jan. 24, 2023.

(51) Int. Cl. B23K 26/067; B23K 26/046; B23K 26/06; B23K 26/0622; B23K 26/362

(52) U.S. Cl. CPC B23K 26/0676; B23K 26/046; B23K 26/0624; B23K 26/0648; B23K 26/362

(57) ABSTRACT

Disclosed herein is an ultrafast, variable multi-focal technique using a laser (such as a picosecond laser or a femtosecond laser) to generate a pulsed laser beam, and a tunable acoustic gradient of index (TAG) lens ahead of an objective lens to achieve multi-focal laser scribing by shaping the pulsed laser beam pulse-by-pulse into a plurality of focal points along an axial axis of the laser beam at one or more selected positions without mechanically moving any optics or sample repositioning. The location of the focal points can be customized and even varied during processing.

### CROSS-REFERENCE TO RELATED APPLICATIONS

The present application claims priority to U.S. Provisional Patent Application No. 63/440,823, filed Jan. 24, 2023, the contents of which are incorporated by reference herein in its entirety.

### TECHNICAL FIELD

The present application is drawn to techniques for laser processing, and specifically to multi-focal laser processing using tunable acoustic lenses.

### BACKGROUND

Shaping the laser beam from a single focus to multiple foci is beneficial for many laser processing applications. In these applications, multi-focal optical systems deliver energy efficiently to multiple designated locations on the beam path. Moreover, the development of multi-focal techniques increases the throughput of tightly focused laser processing systems with high spatial resolutions. For example, the multi-photon absorption of femtosecond laser in transparent materials occurs only in a highly confined focal spot of sub-micrometer size. By expanding the number of processing sites, the multi-focal beam shaping can boost the micromachining speed of transparent materials.

Traditional methods to achieve this goal mostly use diffractive or refractive optics, which can only generate a fixed multi-focal beam pattern once set up. The early invention of the dual-focal lens, for example, is a refractive optical element consisting of two concentric circular regions with different focal lengths. Another refractive optics method adopts a modified Newton's ring setup, which employs a beam splitter, a convex mirror, and a focusing lens to output two collinear beams. Alternatively, one can use diffractive optical elements with the Fresnel zone plate (FZP) pattern to generate multiple foci. The computed FZP pattern can be directly fabricated by lithography. This method is adaptable in terms of the number of foci, the operating wavelength, and the energy distribution, but these parameters are all pre-set prior to manufacturing. The recent advent of adaptive optics has paved the way for a more flexible beam shaping. The phased-engineered patterns or the computer-generated holograms can be projected on digital micromirror devices (DMDs) or spatial light modulators (SLMs). However, many of the reported response rates are less than 100 Hz. Overall, the above multi-focal methods may not adjust dynamically and promptly. They may also suffer from complexity in computation and overall fabrication. The lack of response rate and flexibility limits the efficiency of focal control and restricts multi-focal techniques to only certain applications. Fast and tunable alteration of focal positions to tailor focusing as needed remains a challenging task.

### BRIEF SUMMARY

In various aspects, a method for quasi-simultaneous multi-focal laser processing may be provided. The method may include comprising generating a pulsed laser beam using a laser (such as a nanosecond laser, a picosecond laser, a femtosecond laser, and/or an attosecond laser). The method may include using a tunable acoustic gradient of index (TAG) lens to shape the pulsed laser beam pulse-by-pulse into a plurality of focal points along an axial axis of the laser beam at one or more selected positions without mechanically moving any optics or sample repositioning. The lens and laser may be controlled in one or more modes, such as a synchronous mode, or an asynchronous mode. The method may include selecting at least mode of operation. The method may include, in synchronous mode, triggering the laser at one or more selected phases of the TAG lens by a trigger signal from a TAG controller. The method may include, in asynchronous mode, allowing the laser to pulse at its configured repetition rate while the TAG lens scans continuously without externally triggering the laser. The method may include directing the laser beam towards a target substrate.

In certain embodiments, shaping the pulsed laser beam may cause ablation of a first surface of the target substrate and a second surface of the target substrate opposite the first surface. In certain embodiments, shaping the pulsed laser beam may cause partial ablation of a first layer of the target substrate and partial ablation of a second layer of the target substrate, the laser beam passing through the first layer to reach the second layer.

The method may include generating one or more patterns in or on the target substrate, e.g., via translating the target substrate or the TAG lens and an objective lens operably coupled to the TAG lens. In certain embodiments, the method may include translating the target substrate in at least one direction parallel to an xy plane, the axial axis being orthogonal to the xy plane. In certain embodiments, the method may include translating, in at least one direction parallel to an xy plane, the TAG lens and an objective lens operably coupled to the TAG lens, the axial axis being orthogonal to the xy plane. The method may include adjusting a location of one or more of the plurality of focal points along the axial axis of the pulsed laser beam during processing without mechanically moving or substituting any optics. The location of the one or more focal points may be determined prior to processing. The location of the one or more focal points may be determined during processing.

In various aspects, a system for quasi-simultaneous multi-focal laser processing may be provided. The system may include a laser configured to generate a pulsed laser beam. The system may include a tunable acoustic gradient of index (TAG) lens in the optical path of the laser beam. The system may include an objective lens in the optical path of the pulsed laser beam after the TAG lens. The system may include a TAG controller, which may be configured to power the TAG lens via a radio frequency (RF) signal and send a trigger signal to the laser to enable focal control.

In certain embodiments, an axial focal position oscillates continuously as a function of time.

The laser and the TAG lens may be operated in one or more modes, such as a synchronous mode or an asynchronous mode. In synchronous mode, the laser may be run synchronized with the TAG lens. For example, in the synchronized mode, the laser may be triggered at one or more selected phases of the TAG lens by a trigger signal from the TAG controller. In asynchronous mode, the laser may be run asynchronized with the TAG lens. For example, in the asynchronous mode, the laser may pulse at its repetition rate while the TAG lens scans continuously without externally triggering the laser.

The system may include one or more translation stages. In certain embodiments, the system may include a first translation stage configured to translate, in at least one direction parallel to an xy plane, either (i) the TAG lens and the objective lens or (ii) a target substrate, an axial axis of the objective lens being orthogonal to the xy plane. In certain embodiments, the system may include a second translation stage configured to translate, in at least one direction parallel to the xy plane, whichever of (i) the TAG lens and the objective lens or (ii) a target substrate is not translated by the first translation stage. In certain embodiments, the first translation stage may translate the TAG lens and object lens in a first direction (e.g., in the x-direction) and the second translation stage may translate the target substrate in a second direction perpendicular to the first direction (e.g., in the y-direction). The system may be configured to adjust a location of one or more of a plurality of focal points along an axial axis of the pulsed laser beam during processing without mechanically moving or substituting any optics. The location of the one or more of the plurality of focal points may be determined prior to processing. The location of the one or more of the plurality of focal points may be determined during processing.

### BRIEF DESCRIPTION OF DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1A is an illustration of a disclosed system.

FIG. 1B is a block diagram of a second embodiment of a disclosed system.

FIG. 2A is a graph showing an example signal sent to a TAG lens.

FIG. 2B is a graph showing continuous oscillation of the TAG lens' focal position z(t).

FIG. 2C is a graph showing a trigger signal synchronized and rising at both phase ϕ=0° and ϕ=180°.

FIGS. 3A and 3B are illustrations of a third embodiment of a disclosed system interacting with different target substrates.

FIG. 4 is an illustration of a fourth embodiment of a disclosed system with translation stages.

FIG. 5 is a flowchart of a method.

FIGS. 6A-6C are lateral images of pulses at 10 axial positions per period in the asynchronous mode (6A), two axial positions per period when triggered at 0° and 180° (6B), and three axial positions per period when triggered at 0°, 90°, and 180° (6C).

FIG. 7A is a graph of r² versus ln(E) representing the radii of craters produced with a single pulse.

FIG. 7B is an optical microscopy image displaying a top view of the z-scan ablation experiment on a Silicon wafer; z_{tag} is measured by the ablation range in the z axis.

FIG. 7C is a graph showing the z-scan ablation experiment to measure the focal oscillation amplitude ztag.

FIG. 7D is a graph showing experimental lens power of the TAG lens as a function of its phase op(φ), measured by a wavefront sensor. Wavefront shapes for φ=0° and φ=180° are included as insets.

FIG. 7E is a graph showing a simulated intensity profile of the single-focal versus the dual-focal mode along the z axis.

FIGS. 8A and 8B show xy plane surface images showing the z-scan line ablation experiments of the multi-layer sample with an incremental step of 100 μm in z, along with graphs showing the depth of the ablated lines on glass and Si for both 10 μJ (8A) and 15 μJ (8B) laser pulse energies.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

The disclosed techniques allocates laser energy to a desired location without mechanically moving any optics. Therefore, the multi-focal system can be employed in many laser processing techniques for transparent materials, such as dicing, scribing, and marking. The system may be employed for processing of chips for LEDs, and other semiconductors. Further, the disclosed techniques have a response rate at the hundreds of kHz scale, allowing for high throughput multi-focal processing to match the emerging ultrafast pulsed lasers at the MHz range.

A strong candidate in pursuing ultrafast beam shaping with a response time of the order of one microsecond is the recently developed class of acousto-optofluidic (AOF) lenses. An AOF lens is a type of liquid adaptive lens driven by piezoelectric materials. The induced acoustic standing waves inside the liquid lens modulate its refractive index. With AOF lenses, a single laser beam can be engineered into multiple beamlets in the lateral (xy) plane or a scanning focal spot along the axial (z) axis. The family of AOF lenses has already proven effective in applications in both imaging and micromachining.

Disclosed herein is an ultrafast varifocal system that scans the axial dimension using an AOF lens, called the tunable acoustic gradient of index (TAG) lens. A TAG lens can oscillate between a converging and a diverging lens at rates ranging from kHz to MHz. By synchronizing the laser pulses at selective single or multiple phases of the varifocal lens, one can shape the beam pulse-by-pulse into one or several focal spots at selected positions without physically moving any optics.

Disclosed herein is a method and system for simultaneous multi-focal laser scribing. More particularly, disclosed is a process of simultaneous multi-focal laser processing with the goal of achieving efficient marking and scribing. The design, implementation, and characterization of an ultrafast, tunable multi-focal method using a tunable acoustic gradient of index (TAG) lens (an existing product) to achieve simultaneous multi-focal laser processing are disclosed herein. The disclosed laser is shaped pulse-by-pulse into several focal spots at selected positions without mechanically moving any optics or sample repositioning.

The disclosed approach has been applied to applications such as: 1) laser-induced intra-volumetric modification in glass with multiple focal spots, and 2) dual-focal laser machining on both surfaces of a transparent glass slide in a single lateral scan. In addition, the disclosed multi-focal method can be employed in many other laser processing techniques for transparent materials, such as laser-based dicing, scribing, and marking.

By way of background, traditional methods to achieve multiple focal spots include beam shaping with diffractive or refractive optics. However, these methods can only generate a fixed multi-focal beam pattern once set up, or only have a limited flexibility with a low response rate (<100 Hz), thus they may not adjust dynamically and promptly. In addition, they may suffer from the other drawbacks of complexity in computation, and overall fabrication. Fast and tunable alteration of focal positions to tailor focusing as needed remains a challenging task. The approach disclosed herein employs an ultrafast tunable TAG lens to shape the beam without physically moving any optics. The response rate of the disclosed method is at the hundreds of kHz scale, allowing for high throughput multi-focal processing to match the emerging ultrafast pulsed lasers with output frequencies in the MHz regime.

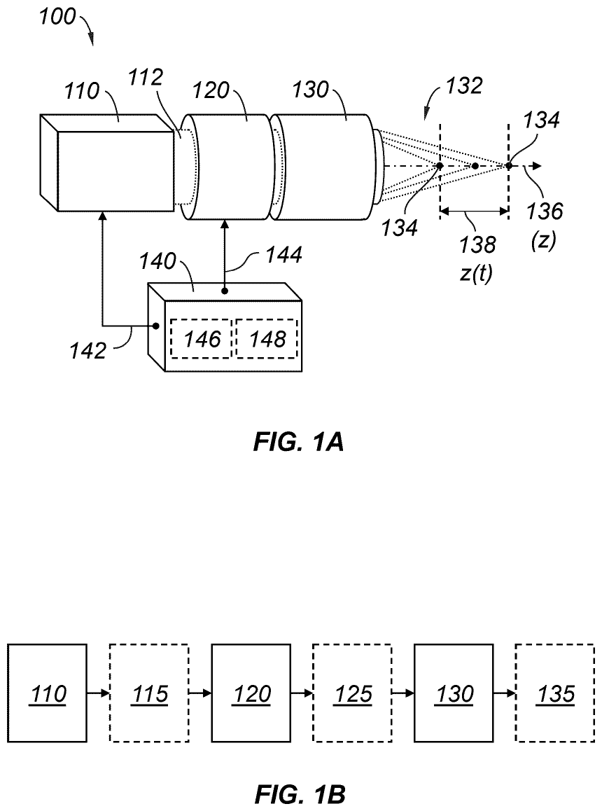

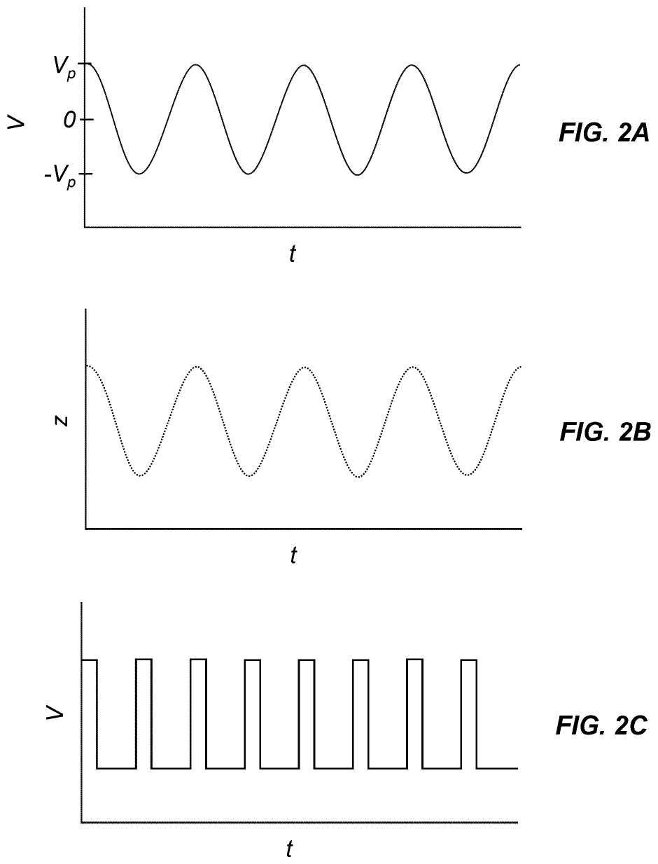

FIG. 1A shows a schematic of a disclosed system, which may be used for, e.g., multi-focal micromachining. The system 100 may include a laser 110 which is configured to generate a pulsed laser beam 112. The laser may be a laser constant or varying pulse durations. In some embodiments, the pulse durations may be, e.g., nanosecond, picosecond, femtosecond, or attosecond pulse durations. In some embodiments, the laser may be a nanosecond laser having pulse durations in the nanosecond regime (e.g., 1 nanosecond≤pulse duration<1 microsecond). In some embodiments, the laser may be a picosecond laser having pulse durations in the picosecond regime (e.g., 1 picosecond≤pulse duration<1 nanosecond). In some embodiments, the laser may be a femtosecond laser having pulse durations in the femtosecond regime (e.g., 1 femtosecond≤pulse duration<1 picosecond). In some embodiments, the laser may be an attosecond laser having pulse durations in the attosecond regime (e.g., 1 attosecond≤pulse duration<1 femtosecond). In some embodiments, the laser may have a pulse duration less than 1 microsecond. In some embodiments, the laser may have a pulse duration less than 1 nanosecond. In some embodiments, the laser may have a pulsed duration less than 1 picosecond.

The pulsed laser beam may emit at any useful wavelength(s) of light. In some embodiments, the pulsed laser beam may include one or more wavelengths in the visible wavelength range (e.g., about 400 nm to about 700 nm). In some embodiments, the pulsed laser beam may include one or more wavelengths in the ultraviolet wavelength range (e.g., about 10 nm to about 400 nm). In some embodiments, the pulsed laser beam may include one or more wavelengths in the infrared wavelength range (e.g., about 700 nm to about 1 mm). In some embodiments, the pulsed laser beam may include one or more wavelengths in the near-infrared wavelength range (e.g., about 700 nm to about 1.4 μm).

The laser 110 may be operably coupled to a TAG lens 120. The pulsed laser beam 112 may be configured to reach the TAG lens either directly (as shown in FIG. 1A) or indirectly (e.g., via one or more optional intervening components 115, such as mirrors, beam splitters, lenses, optical cables, etc., as shown in FIG. 1B). An appropriate TAG lens may be one sold under the name TAGLENS™ varifocal lens by Mitutoyo.

The system may include an objective lens 130 in the optical path of the laser beam, after the TAG lens 120. In some embodiments, as shown in FIG. 1A, the TAG lens and the objective lens are coupled together with no intervening components between them. In some embodiments, one or more optional intervening components 125 (mirrors, beam splitters, lenses, optical cables, etc.) may be disposed between the TAG lens and the objective lens.

The output laser beam 132 from the objective lens will have a focal point 134 that varies along an axial axis 136 (e.g., the z-axis) over time. As shown in FIG. 1A, there may be no components after the objective lens, between the lens and any target of the laser beam. In some embodiments, one or more optional components 135 (mirrors, beam splitters, lenses, optical cables, etc.) may be disposed after the lens, between the lens and any target of the laser beam.

The system may include a TAG controller 140. As will be understood, the TAG controller may include one or more processing units 146 and may include one or more non-transitory computer-readable storage devices 148 operably coupled to the one or more processing units. The non-transitory computer-readable storage device(s) may include instructions that, when executed by the one or more processing units, configure the processing unit(s) to, collectively, perform the functions of the TAG controller.

The TAG controller may be operably coupled to the TAG lens 120. The TAG controller may be operably coupled to the laser 110.

In FIG. 1A, the axial (z-direction, along axial axis 136) position of a focal point 134 of the output laser beam 132 at any given time t may vary (such as oscillating continuously 138) as a function of time t. Here, the positive z direction is denoted as the beam propagation direction, with z=0 at the exit of the objective lens.

The TAG lens may be powered by a signal 144, such as an RF signal, with an amplitude of Vₚ, from the TAG controller. An example of this signal is plotted in FIG. 2A.

Unlike a conventional single-focal setup, the focal position of the laser beam measured after the objective lens z(t) is described by

$$z ( t ) \approx {z}_{0} + {z}_{tag} cos ( 2 π {f}_{tag} t + {ϕ}_{0} ) , \qquad ( 1 )$$

where z₀, z_{tag}, and f_{tag} are the average, the amplitude, and the frequency of the oscillating focal position in z. Here ϕ₀ is an arbitrary initial phase. Taking ϕ₀ as 0, z(t) is plotted in FIG. 2B. Lumping all the phase terms in z(t), one can also describe the scanning focal position as

$$z ( ϕ ) \approx {z}_{0} + {z}_{tag} cos ( ϕ ) , \qquad ( 2 )$$

where ϕ, the oscillation phase, is a useful parameter for the focal control method as it may be used to trigger the laser. Here z₀ is measured as the average of the minimum and maximum of z(t), also corresponding to z(90°). The frequency f_{tag} may be determined by the driving frequency of the signal 144 to the TAG lens, and may be set at the resonance frequencies of the piezoelectric shell inside the TAG lens. The focal oscillation amplitude z_{tag} is linearly proportional to the amplitude Vₚ of the signal 144 to the TAG lens. Fundamentally, z_{tag} is determined by the optical power of both the objective lens and the TAG lens. Considering an objective lens with a focal length of f₀ and placed immediately next to the TAG lens,

$$\frac{1}{z ( ϕ )} = \frac{1}{{f}_{0}} + op ( ϕ ) , \qquad ( 3 )$$

where op(ϕ) represents the oscillating optical power of the TAG lens, and is a sine/cosine function of ϕ. Thus, the total scanning range is

$$2 {z}_{tag} = z ( 0 ° ) - z ( 180 ° ) \approx {f}_{0}^{2} \cdot [ op ( 180 ° ) - op ( 0 ° ) ] {z}_{0} + {z}_{tag} cos ( ϕ ) . \qquad ( 4 )$$

Note that the approximation of z(t), z(ϕ), and z_{tag} in Eqs. (1)-(4) is only valid when |op(ϕ)|<<1. This condition holds for most micromachining systems because the optical power of the TAG lens is of the scale of m⁻¹, which is significantly lower than that of the objective lens.

FIG. 1A and FIG. 2B show a continuous oscillation 138 of the focal length in response to the signal from the TAG controller (see, e.g., FIG. 2A).

Referring to FIG. 1A and FIG. 2C, in some embodiments, a trigger signal 142 may be sent from the TAG controller, synchronized with one or more phases of the lens (to achieve one or more desired focal lengths). In FIG. 2C, the trigger signal is synchronized with phase ϕ=0° and ϕ=180° of the lens, but it as will be understood, other selections could be readily utilized.

In some embodiments, the TAG controller may be configured to power the TAG lens via an RF signal and send a trigger signal to the laser to enable focal control. As noted above, the focal point is thus controlled by the RF signal, and when the laser is triggered via a trigger signal will determine the focal point of the pulse of laser generated by that trigger signal.

As will be understood, the system may be configured to adjust a location of one or more of the focal points along the axial axis of the pulsed laser beam during processing without mechanically moving or substituting any optical element. As noted above, this can be done by, e.g., triggering the laser at different times, or adjusting the RF signal sent to the TAG lens. As will be understood, this is not something that can be accomplished with traditional optical lenses, including diffractive optical elements. To adjust focal points with traditional optical lenses during processing, you would need to, e.g., mechanically move some optical element, rebuild the system, or substitute one or more optical elements with different elements.

In certain embodiments, the location of the focal points may be predetermined (e.g., determined prior to processing). This may be done, e.g., prior to any etching, dicing, scribing, etc., and/or may be prior to providing power to the system. For example, one or more files could be used to define when certain actions would start and/or stop (e.g., at time t=0, start sending RF signal to TAG lens; a time t=1, send trigger signal 1 for 10 seconds; at time t=2, send trigger signal 2 for 5 seconds). A user could predefine the settings the system should use create in order to create a particular pattern of focal points.

In certain embodiments, the location of the focal points may be adjusted during processing (e.g., not determined prior to processing). For example, the system may receive information from a sensor (such as a thickness of a target substrate), and based on the sensor's information, the RF signal or trigger signals may be adjusted to etch the surfaces in a desired manner. Alternatively, the system may receive input from a user during processing, and may adjust the processing based on that input.

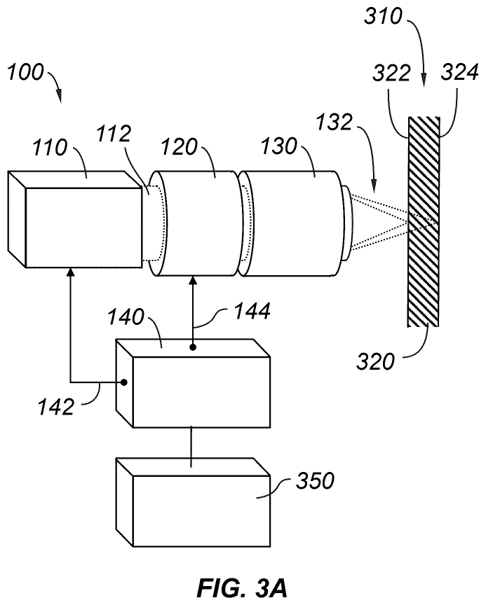

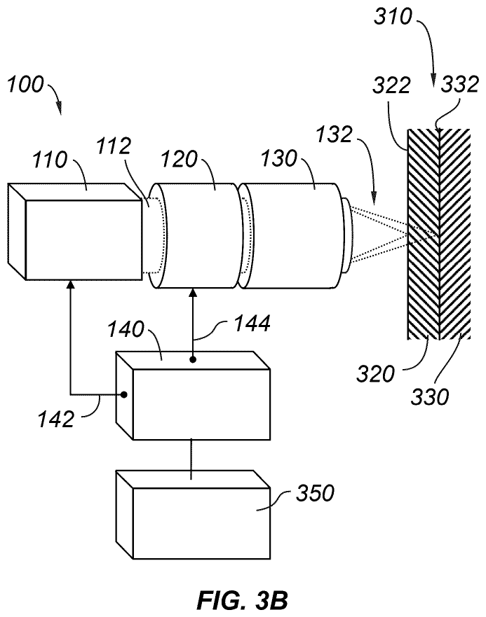

Referring to FIG. 3A, the pulsed laser may be directed at a target substrate 310. In this manner, it is possible to use the pulsed laser to ablate a one or more surfaces. The target substrate may be any laser-ablatable material. In some embodiments, the target substrate may comprise or consist of a glass, a metal, or a polymer. In some embodiments, the target substrate may comprise or consist of a semiconductor.

As shown in FIG. 3A, the target substrate 310 may have a single layer (e.g., first layer 320). In some embodiments, the target substrate may have a first surface 322 and a second surface 324 opposite the first surface. The TAG lens may be controlled to allow the pulsed laser to ablate both the first surface 322 and the second surface 324 of the target substrate.

As also shown in FIG. 3A, it is also recognized that one or more additional components 350 may be operably coupled to the TAG controller. In some embodiments, the additional components may include power supply circuitry. In some embodiments, the additional components may be include or more switches. In some embodiments, the additional components may include one or more remote processing units, which may be coupled to their own non-transitory computer readable storage devices. In some embodiments, one or more remote processing unit(s) may, collectively, send information to the TAG controller, the information being used to control, e.g., the trigger signal 142 or the signal 144 to the TAG lens. For example, a remote processing unit(s) may read information from a database, file, etc., that defines a processing step (such as a length of time at a particular amplitude of the TAG lens), and that information is then used to control the TAG lens and/or the trigger signal.

Referring to FIG. 3B, the pulsed laser may be directed at a target substrate 310 having multiple layers (e.g., a first layer 320 and a second layer 330). The TAG lens may be controlled to allow the pulsed laser to ablate both the first surface 322 of the first layer 320 and a first surface 332 of the second layer 330 of the target substrate.

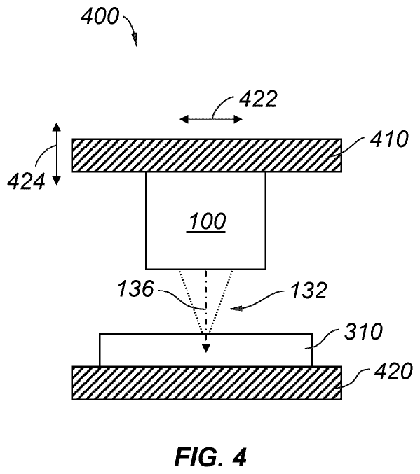

Referring to FIG. 4, the system may include one or more translation stages operably coupled to the TAG lens and objective lens, to a target substrate, or both. In some embodiments, only a single translation stage is utilized. In some embodiments, only a stage operably coupled to the TAG lens and objective lens is utilized.

In certain embodiments, some or all of the system with the TAG lens (e.g., system 100) may be operably coupled to a translation stage 410. In some embodiments, the portion of the system from the TAG lens and afterwards (TAG lens 120, any optional components 125, objective lens 130, and any optional components 135) is coupled to the translation stage. In some embodiments, the entire system 100 may be operably coupled to the translation stage.

In certain embodiments, the translation stage may be configured to translate the system 100 in three dimensions, e.g., in a direction 424 parallel to the axial axis 136 (z-direction), and in any direction 422 parallel to an xy plane (the axial axis 136 being orthogonal to the xy plane). In certain embodiments, the translation stage may be configured to translate the system 100 in two dimensions (e.g., in the xz plane, etc.). In certain embodiments, the translation stage may be configured to translate the system 100 in only a single dimension (e.g., in a direction perpendicular to axial axis 136, etc.).

In certain embodiments, a translation stage 420 may be configured to maneuver a target substrate 310 into the optical path of the laser beam. In certain embodiments, the translation stage may be configured to translate the system 100 in three dimensions, e.g., in a direction 424 parallel to the axial axis 136 (z-direction), and in any direction 422 parallel to an xy plane (the axial axis 136 being orthogonal to the xy plane). In certain embodiments, the translation stage may be configured to translate the system 100 in two dimensions (e.g., in the xz plane, etc.). In certain embodiments, the translation stage may be configured to translate the system 100 in only a single dimension (e.g., in a direction perpendicular to axial axis 136, etc.).

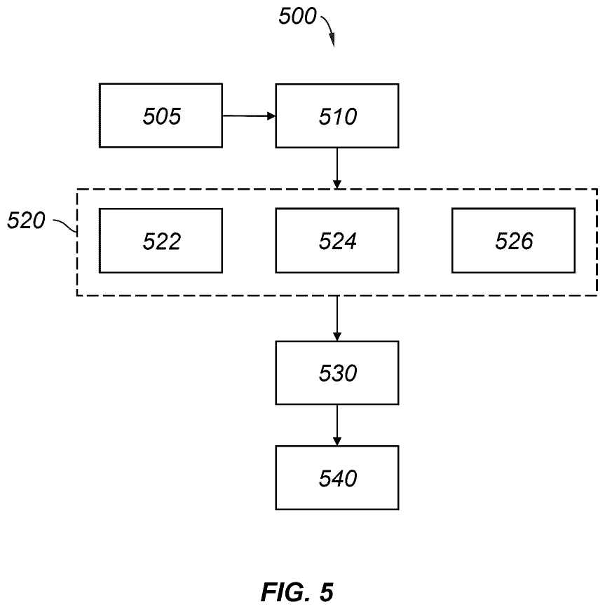

In various aspects, a method for quasi-simultaneous multi-focal laser processing may be provided. Referring to FIG. 5, a method 500 may include generating 510 a pulsed laser beam using a laser (such as with a nanosecond laser, a picosecond laser, a femtosecond laser, and/or an attosecond laser).

The method may include operating the laser in a synchronized (or “synchronous”) mode. The method may include triggering 505 the laser at one or more selected phases of a TAG lens by a trigger signal, which may be from a TAG controller.

The method may include operating the laser in an asynchronized (or “asynchronous”) mode. The method may include allowing the femtosecond laser to pulse at its configured (i.e., not triggered by a trigger signal) repetition rate while the TAG lens scans continuously without externally triggering the laser.

The method may include using 520 a TAG lens to shape the pulsed laser beam pulse-by-pulse into a plurality of focal points along an axial axis of the laser beam at one or more selected positions without mechanically moving any optics or sample repositioning. This may include having a TAG controller send 522 a signal (such as an RF signal) to the TAG lens. This may include having the TAG lens receive 524 a signal (such as an RF signal). This may include controlling 526 oscillations of the TAG lens based on a signal (such as an RF signal).

It will be understood that the triggering and controlling the TAG lens may be done in any order. In some embodiments, the TAG lens may receive a signal first, and then the laser may receive the trigger signal afterwards. In some embodiments, the two signals may be sent and/or received simultaneously. In some embodiments, the laser may receive a trigger signal first and the TAG lens may receive a signal afterwards.

The method may include directing 530 the laser beam towards a target substrate or otherwise allowing the laser beam to reach the target substrate. This “directing” may include using an objective lens to direct the laser towards a target substrate.

In certain embodiments, shaping the pulsed laser beam may cause ablation of a first surface of a target substrate and a second surface of the target substrate opposite the first surface. In certain embodiments, shaping the pulsed laser beam may cause partial ablation of a first layer of a target substrate and partial ablation of a second layer of the target substrate, the laser beam passing through the first layer to reach the second layer. In certain embodiments, shaping the pulsed laser beam may cause intra-volumetric ablation of a target substrate. For example, in certain embodiments, the shaping may cause ablation of an intermediate portion of a first layer between a first surface portion free of ablation and a second surface portion free of ablation.

The method may include translating 540 the TAG lens and objective lens and/or the target substrate. In certain embodiments, the method may include translating the target substrate in at least one direction parallel to an xy plane, the axial axis being orthogonal to the xy plane. In certain embodiments, the method may include translating, in at least one direction parallel to an xy plane, the TAG lens and an objective lens operably coupled to the TAG lens, the axial axis being orthogonal to the xy plane.

### Example 1

To demonstrate the flexibility of the disclosed approach in manipulating focal positions, laser-induced intra-volumetric modification in a 1 cm six-sided polished cube of borosilicate glass was performed using the disclosed multi-focal machining setup. In this example, femtosecond pulses were directed through the TAG lens and a 40× objective lens [numerical aperture (NA)=0.65], inducing damaged tracks inside the glass sample.

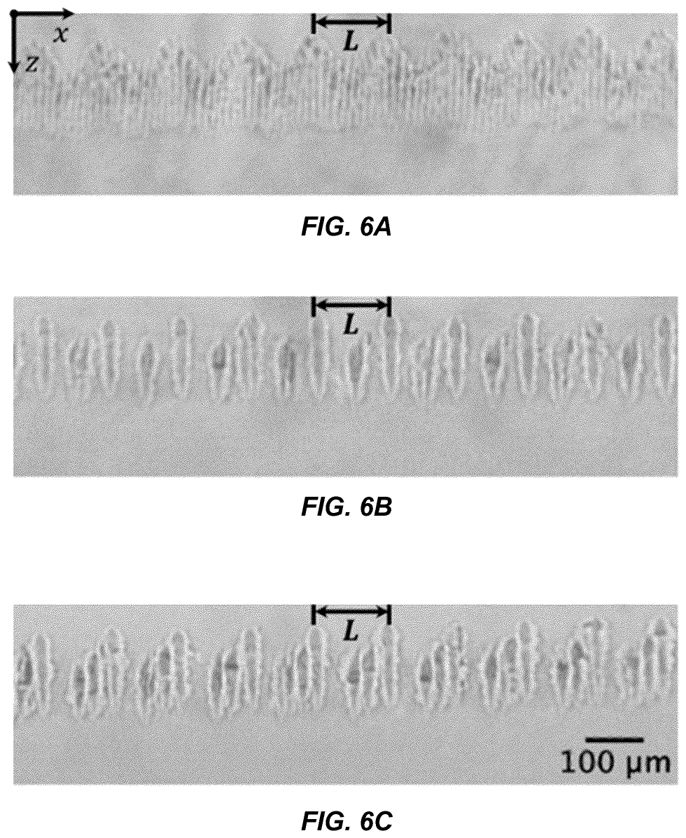

The induced filamentation tracks are imaged laterally (xz plane) with an optical microscope. The async mode and the sync mode with two or three selected phases are compared in FIGS. 6A-6C, with a pulse energy of 300 μJ, where a stage holding the laser, TAG lens, objective lens, and controller moves laterally relative to the glass cube at 10 mm/s in the x direction. Thus, the distance between adjacent tracks in the async mode is 10 μm. For the axial scanning parameters, f_{tag} was set to 140,100 Hz, Vₚ of the driving signal (for the TAG lens) was set to 12 V, and z_{tag} was measured to be roughly 25 μm from the tracks. The frequency ratio between the laser (at 1000 Hz) and the TAG lens (at 140,100 Hz) creates an oscillating pattern with approximately 100 μm in length or equivalently 10 pulses per period in the asynchronous mode. This can be seen in FIG. 6A. In the sync mode shown in FIGS. 6B and 6C only two and three, respectively, out of the previous 10 laser pulses per period (in the asynchronous mode) are triggered at the selected focal positions z=z₀+z_{tag}, z=z₀, and z=z₀−z_{tag}, corresponding to the selected phase ϕ at 0°, 90°, and 180°. The measured average length of the periodic pattern L in FIGS. 6A-6C is L=109 μm. Up to three focal planes are generated per axial scanning period, limited by the triggering signal's width Δt at 1 μs. To avoid overlapping of the triggering signals, the maximum number of planes in a single axial scanning period is 1/(2f_{tag}Δt), which is 3.6 with f_{tag}=140 kHz and Δt=1 μs. However, more axial positions can be created if the triggering phase is varied with time. For example, similar experiments were run showing four focal planes corresponding to the selected phase ϕ at 0°, 60°, 90°, and 180°.

### Example 2

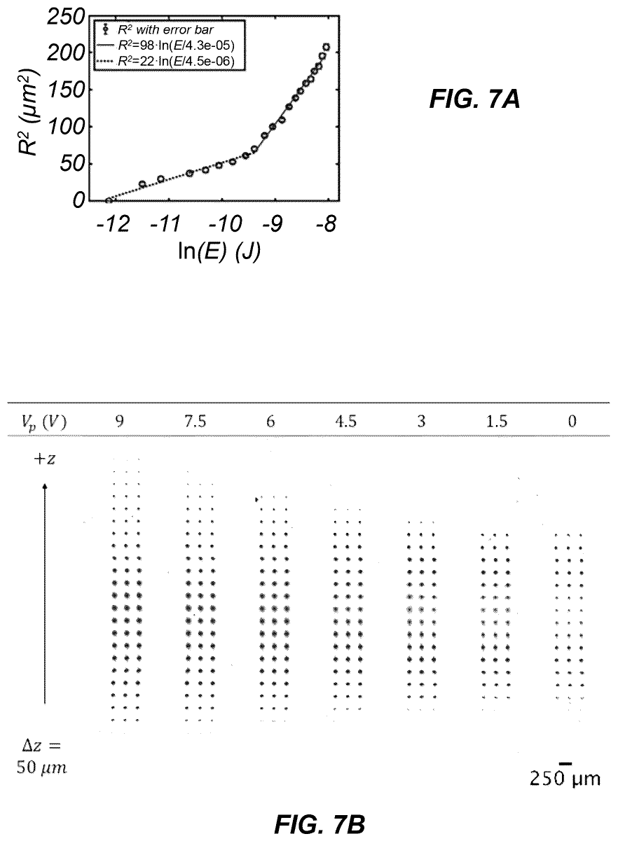

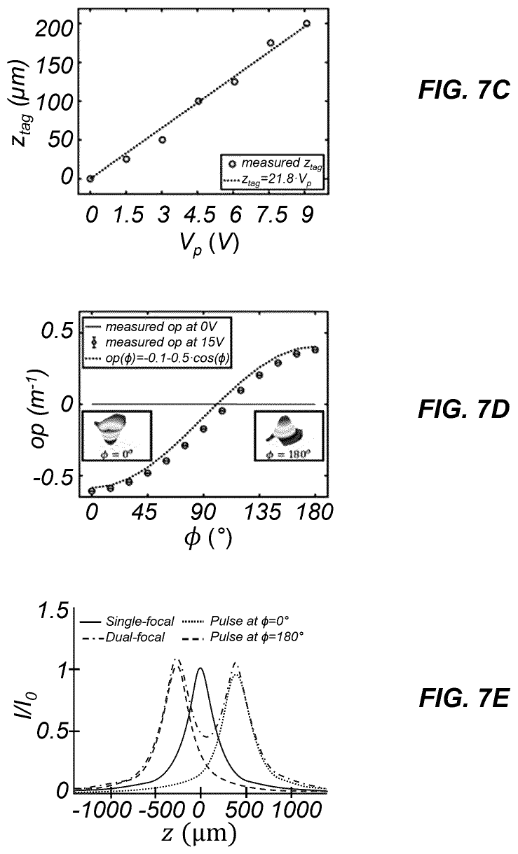

This example investigates dual-focal laser processing in particular for its potential application in transparent material scribing and dicing, which typically involves a single layer with two surfaces. Various ablation experiments are conducted on a Si wafer (500 μm thickness) to characterize the system with a 10× objective lens (NA=0.25). To measure the beam radius, a single-shot ablation experiment was performed following Liu's method (see J. M. Liu, Opt. Lett. 7, 196 (1982)) when the TAG lens is off. The areas of the ablated craters are measured and fitted in two energy regimes. See FIG. 7A. The calculated beam radius w₀ is 7 μm at the low-energy regime. Each data point is repeated five times.

The focal oscillation amplitude z_{tag} of the TAG lens at its resonance frequency (f_{tag}=140,100 Hz) is measured by a z-scan ablation experiment on a Silicon wafer (500 μm thickness), and displayed in FIG. 7C. Laser pulses of 10 μJ are directed through the TAG lens and the 10× objective lens to drill holes on the surface of Si in the async mode, while the TAG lens operates at varying voltages, i.e. Vₚ=0-9 V. FIG. 7B exhibits different sets of dark circular spots corresponding to the hole drilling results, grouped by the applied Vₚ. Each spot is drilled by 1000 pulses and repeated for three times, shown in a row. The z-scan step Δz for each row is 50 μm. For each driving voltage Vₚ, z_{tag} is measured by the ablation range in the z axis. The ablation range is estimated by multiplying the number of the ablated holes column-wise (n) by the z-scan step size.

Thus, z_{tag} is calculated by

$$\frac{( n - {n}_{0} ) Δ z}{2} ,$$

where n₀ is the number of the ablated holes when Vₚ=0 V.

In FIG. 7C, z_{tag} is measured from the ablation range in the z axis for each driving voltage Vₚ and fitted for a linear relation. Using this relation, one can look up for appropriate Vₚ for a specific z_{tag}. To characterize the lens power of the TAG lens op(ϕ), laser pulses are triggered at several single phases between 0° and 180°, and the beam curvature at each phase is measured five times using a Shack-Hartmann wavefront sensor. FIG. 7D plots the characterized optical power op(ϕ) for Vₚ=15 V and a cosine fit to ϕ.

Importantly, it is noticed that the average optical power is not aligned with the zero optical power at TAG off (Vₚ=0 V, in solid line). This asymmetric optical power at the maximum diverging (0°) and converging (180°) phases stems from its lens mechanics. Due to the oscillating optical power of the TAG lens, the variation in NA changes the beam spot size, which influences the ablation characteristics on materials. To assess this effect, one can simulate the fluence of the beam at different phases. FIG. 7E simulates the normalized intensity profile of the single-focal versus the dual-focal mode along the z axis. We also compare the fluence distributions for the single-focal and dual-focal mode, with laser energy of 10 μJ. Assuming a constant entrance beam size, NA(φ)∝z(φ). For a 10× objective lens with NA=0.25, NA(φ) varies between 0.247 to 0.254, based on z(180°) and z(0°) calculated by Eq. 2. The variation in NA and beam spot size is responsible for the different ablation characteristics observed in these experiments.

### Example 3

Finally, one can exploit the multi-focal nature of the method to prove the feasibility of laser machining on both sides of a transparent microscope glass slide in a single lateral scan. A target substrate includes a transparent glass slide of 1 mm thickness positioned on top of a Si wafer of 500 μm thickness and mounted on a stage, with defined axes of x (width), y (length), and z (depth) of the substrate. As disclosed herein, z points in the beam propagation direction. At the exit of the objective lens z is zero. For this example, the top surface of the glass slide is sometimes referred to as surface A, and the Si surface (in contact with the bottom surface of the glass slide) as surface B. In the single-focal mode or when the TAG lens is turned off, one can only ablate the surface at A or B by focusing at the close vicinity of A or B. Since the distance between surfaces A and B is substantially larger than the Rayleigh length of the laser beam (<200 μm), simultaneous ablation of A and B is impossible.

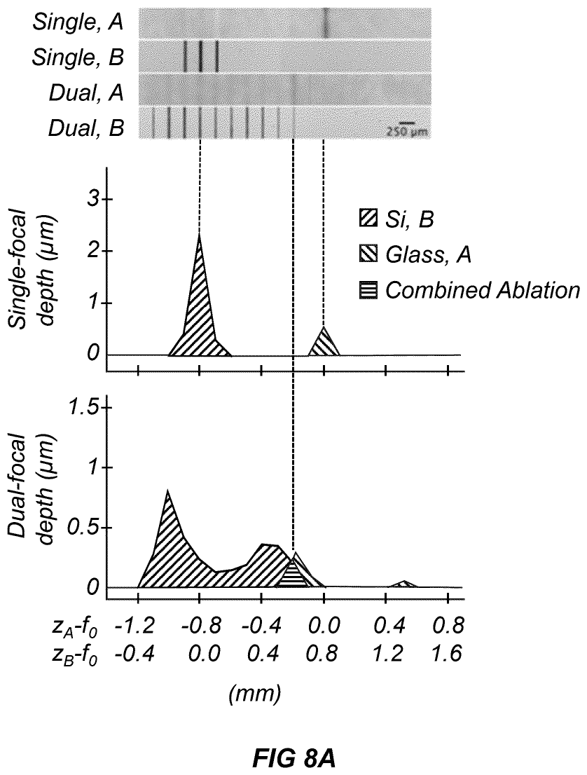

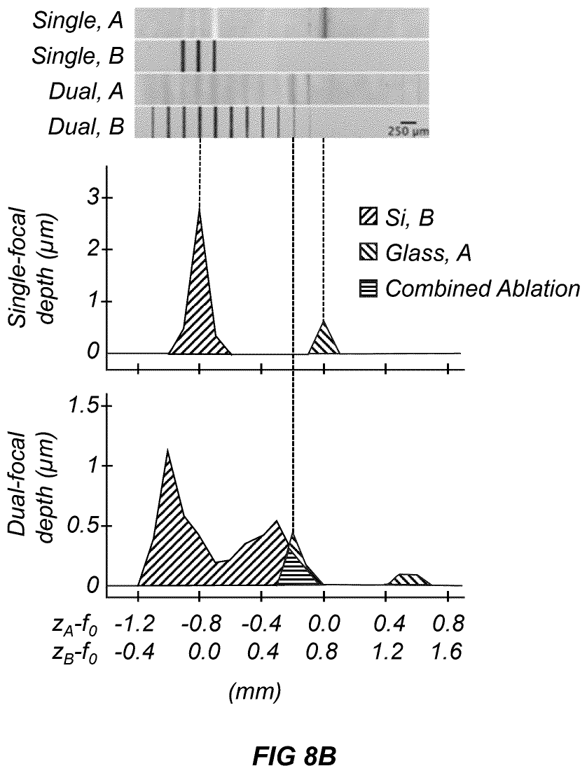

A z-scan line ablation experiment with our multi-layer sample is included in FIGS. 8A and 8B. Here one can compare the single-focal (TAG off) and dual-focal (TAG on) modes. For both images, starting from the right, each line corresponds to an ablated line along the x axis, with a z incremental step of 100 μm (moving away from the objective lens). Laser pulses with energies of 10 μJ (8A) and 15 μJ (8B) are directed through the TAG lens and the 10× objective lens to the sample. The lateral speed of the stage in x is 0.65 mm/s. For clear notation, the locations of both surfaces are denoted by z_{A}−f₀ and z_{B}−f₀. For example, when the laser focuses on the surface A in the single-focal mode, z_{A}−f₀=0.

One can approximate the optical distance between two surfaces using the physical thickness of the glass divided by its refractive index (at around 1.5), which gives a distance of 667 m. From the experiment in the single-focal mode shown in FIG. 8A, z distance between the ablated lines on A and B is measured between 700 and 800 μm. The difference between the calculated and measured value is acceptable considering the relatively low resolution of z stage with a coarse step size of 100 μm. The strategy to ablate both surfaces with one lateral scan is to direct sync pulses at φ=0° to surface B and sync pulses at φ=180° to surface A. Therefore, the focal scanning amplitude z_{tag} should be half of the distance between the two surfaces, which in our sample is around 334 μm from the theoretical calculation of the distance. Using the linear relation between Vₚ and z_{tag} in the characterization (see FIG. 7C), one can set Vₚ to 15 V f_{tag} to 140,100 Hz, so that z_{tag} is matched at 327 μm. In the dual-focal mode, combined ablation lines appear on both A and B at z_{A}=f₀−0.2 mm (z_{B}=f₀+0.6 mm), indicating both surfaces are ablated at the same z location.

To better compare the single-focal and the dual-focal mode, the depth of the ablated lines on glass and Si are measured by a confocal microscope, in the graphs of both FIGS. 8A and 8B. Errors were calculated from the standard deviation of the depth for a total of 1024 data points (or 256 μm in length) along the ablated line in the x axis. When the scanning center z₀ is positioned at the center of two surfaces, the maximum converging beam at φ=180° is focused on the surface A and the maximum diverging beam at φ=0° is focused on the surface B. This corresponds to the optimal ablation case where surface A is positioned off focus toward the objective lens by 0.2 mm. The overlapped shaded areas also indicate that both surfaces are ablated at the same location (z_{A}−f₀=−0.2 mm). The asymmetry of the ablation depth in the dual-focal mode, compared with the single-focal mode, originates from the optical power of the TAG lens as disclosed herein. Since only half of the pulses are deposited on each surface, the ablated depths of both materials are about half of those in the single-focal mode.

It is not possible to mark two overlapping surfaces in a single lateral scan using a single-focal approach; it is only possible with the disclosed multi-focal approach.

As will be understood, while the Example above utilized only a two-layer substrate, additional layers can also be incorporated, with only some experimentation needed to select the appropriate trigger timing to achieve the desired ablation depths.

Various modifications may be made to the systems, methods, apparatus, mechanisms, techniques, and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method for quasi-simultaneous multi-focal laser processing, comprising:
generating a pulsed laser beam using a laser; and
using a tunable acoustic gradient of index (TAG) lens to shape the pulsed laser beam pulse-by-pulse into a plurality of focal points along an axial axis of the pulsed laser beam at one or more selected positions without mechanically moving any optics or sample repositioning.

2. The method of claim 1, wherein the laser has a pulse duration less than 1 microsecond.

3. The method of claim 2, wherein the laser has a pulse duration of at least 1 picosecond and less than 1 nanosecond.

4. The method of claim 2, wherein the laser has a pulse duration of at least 1 femtosecond and less than 1 picosecond.

5. The method of claim 1, further comprising triggering the laser at one or more selected phases of the TAG lens by a trigger signal from a TAG controller.

6. The method of claim 1, further comprising allowing the laser to pulse at its configured repetition rate while the TAG lens scans continuously without externally triggering the laser.

7. The method of claim 1, further comprising directing the pulsed laser beam towards a target substrate.

8. The method of claim 7, wherein shaping the pulsed laser beam causes ablation of a first surface of the target substrate and a second surface of the target substrate opposite the first surface.

9. The method of claim 7, wherein shaping the pulsed laser beam causes partial ablation of a first layer of the target substrate and partial ablation of a second layer of the target substrate, the pulsed laser beam passing through the first layer to reach the second layer.

10. The method of claim 7, further comprising translating the target substrate in at least one direction parallel to an xy plane, the axial axis being orthogonal to the xy plane.

11. The method of claim 1, further comprising translating, in at least one direction parallel to an xy plane, the TAG lens and an objective lens operably coupled to the TAG lens, the axial axis being orthogonal to the xy plane.

12. The method of claim 1, further comprising adjusting a location of one or more of the plurality of focal points along the axial axis of the pulsed laser beam during processing without mechanically moving or substituting any optics.

13. The method of claim 12, wherein the location of the one or more of the plurality of focal points is determined prior to processing.

14. The method of claim 12, wherein the location of the one or more of the plurality of focal points is determined during processing.

15. A system for quasi-simultaneous multi-focal laser processing, comprising:
a laser configured to generate a pulsed laser beam;
a tunable acoustic gradient of index (TAG) lens in an optical path of the pulsed laser beam;
an objective lens in the optical path of the pulsed laser beam after the TAG lens; and
a TAG controller configured to power the TAG lens via an RF signal and send a trigger signal to the laser to enable focal control.

16. The system of claim 15, wherein an axial focal position oscillates continuously as a function of time.

17. The system of claim 15, wherein the laser is run synchronized with the TAG lens.

18. The system of claim 17, wherein in synchronized mode, the laser is triggered at one or more selected phases of the TAG lens by the trigger signal from the TAG controller.

19. The system of claim 15, wherein the laser is run asynchronized with the TAG lens.

20. The system of claim 19, wherein in asynchronized mode, the laser is configured to pulse at its repetition rate while the TAG lens scans continuously without externally triggering the laser.

21. The system of claim 15, further comprising a first translation stage, the first translation stage configured to translate, in at least one direction parallel to an xy plane, either (i) the TAG lens and the objective lens or (ii) a target substrate, an axial axis of the objective lens being orthogonal to the xy plane.

22. The system of claim 21, further comprising a second translation stage, the second translation stage configured to translate, in at least one direction parallel to the xy plane, whichever of (i) the TAG lens and the objective lens or (ii) a target substrate is not translated by the first translation stage.

23. The system of claim 22, wherein the first translation stage translates the TAG lens and object lens in a first direction and the second translation stage translates the target substrate in a second direction perpendicular to the first direction.

24. The system of claim 15, wherein the system is configured to adjust a location of one or more of a plurality of focal points along an axial axis of the pulsed laser beam during processing without mechanically moving or substituting any optics.

25. The system of claim 24, wherein the location of the one or more of the plurality of focal points is determined prior to processing.

26. The system of claim 24, wherein the location of the one or more of the plurality of focal points is determined during processing.
